(19) United States
(12) Patent Application Publication
(10) Pub. No.: US 2026/0339818 A1
(43) Pub. Date: Oct. 29, 2026

(54) ACCEPTANCE-CONTROL LAYER FOR VERIFIED AI-GENERATED CODE

(71) Applicant: George William Bickerstaff, III, Greenwich, CT (US)

(72) Inventor: George William Bickerstaff, III, Greenwich, CT (US)

(21) Appl. No.: 19/674,005

(22) Filed: May 11, 2026

(51) Int. Cl. G06F 11/3604

(52) U.S. Cl. CPC G06F 11/3608

(57) ABSTRACT

Disclosed is an acceptance-control layer for AI-generated software code, implemented as a system, method, and non-transitory computer-readable medium. A hardware-enforced deployment gate prevents transmission of candidate code outside a trusted execution environment (TEE) until four conditions are simultaneously satisfied: (i) a formal verification engine produces a machine-checkable proof of one or more correctness properties of the candidate code; (ii) a quantum-resistant cryptographic module produces attestation evidence binding the candidate code, the AI agents, and the proof to the hardware-rooted TEE measurement using one or more post-quantum cryptographic algorithms; (iii) a hardware-rooted consensus engine satisfies a policy-defined threshold among a plurality of validators whose eligibility is bound to the hardware-rooted measurement; and (iv) the candidate code, the proof, the attestation evidence, and the consensus decision are recorded in a tamper-evident provenance ledger supporting independent third-party verification.

### CROSS-REFERENCE TO RELATED APPLICATIONS

This application claims the benefit of priority under 35 U.S.C. § 119 (e) to U.S. Provisional Patent Application Ser. No. 64/053,728, filed Apr. 30, 2026 (Confirmation No. 7616; Patent Center No. 75718921; Customer No. 212041), the entire disclosure of which is incorporated herein by reference. Applicant reserves the right to file one or more continuation, continuation-in-part, divisional, and foreign counterpart applications. The disclosures of any co-pending applications directed to hardware-anchored AI code generation, multi-agent governance, federated trust architectures, policy enforcement, and verifiable provenance are incorporated herein by reference to the extent permitted by law.

### STATEMENT REGARDING FEDERALLY SPONSORED RESEARCH OR DEVELOPMENT

Not applicable.

### FIELD OF THE INVENTION

The present disclosure relates to systems, methods, and non-transitory computer-readable media for the formally verified, quantum-resistant, multi-agent generation, verification, and consensus of software code produced by artificial intelligence (AI) models. More particularly, the disclosure relates to architectures in which a plurality of specialized AI agents executes within one or more hardware-rooted trusted execution environments (TEEs); in which mathematical proofs of code properties are computed in real time or within bounded iterations during generation using satisfiability modulo theories (SMT) solvers, theorem provers, model checkers, and Hoare-logic assertions; in which inter-agent communications are protected by zero-knowledge proofs and post-quantum cryptography; and in which acceptance of generated code is gated by hardware-rooted Byzantine consensus and recorded in a tamper-resistant provenance ledger.

### BACKGROUND OF THE INVENTION

AI systems including large language models and other generative architectures increasingly produce executable software code from natural-language prompts, structured specifications, or programmatic inputs. While such tools improve developer productivity, they remain unsuitable as trusted infrastructure in regulated, safety-critical, financial, defense, healthcare, and other high-assurance environments.

TEEs such as Intel SGX, Intel TDX, AMD SEV-SNP, ARM TrustZone, ARM CCA, AWS Nitro Enclaves, Azure Confidential VMs, Google Cloud Confidential VMs, and NVIDIA confidential GPUs are known to provide confidential AI inference and basic remote attestation. Multi-agent AI architectures and formal verification tools (including SMT solvers, theorem provers, and model checkers) are likewise individually known. However, no prior art system integrates (i) real-time or bounded-iteration formal verification within the TEE during multi-agent collaborative code generation, (ii) hardware-rooted Byzantine consensus in which validator identity is bound to TEE attestation, (iii) post-quantum cryptography for both attestation and inter-agent signatures, (iv) self-sovereign agent identities cryptographically linked to hardware attestation, (v) zero-knowledge intermediate proofs as the basis for inter-agent communication, and (vi) federated cross-vendor TEE networks producing a unified verifiable artifact.

The absence of such an integrated platform prevents organizations subject to regulatory regimes including HIPAA, GDPR, PCI-DSS, FDA 21 C.F.R. Part 11, SOX, FedRAMP, ISO/IEC 27001, DO-178C Level A, IEC 62304, MIL-STD-882, MiFID II, and Basel III/IV from adopting AI-generated code in production; exposes those that do adopt such code to security, regulatory, and existential cryptographic risks, including “harvest-now, decrypt-later” quantum attacks; and frustrates third-party verification, post-incident forensics, and regulatory examination. Accordingly, there is a need for a system that produces mathematically provable, post-quantum-secure, attested AI code artifacts through coordinated multi-agent generation within hardware-rooted execution environments.

### SUMMARY OF THE INVENTION

Disclosed are a system, a method, and a non-transitory computer-readable medium that produce formally verified, quantum-resistant, multi-agent-generated software code within hardware-rooted trusted execution environments. An orchestration layer executing within at least one TEE spawns a plurality of specialized AI agents. A formal verification engine within the TEE computes mathematical proofs of code properties using SMT solvers, theorem provers, model checkers, and Hoare-logic assertions. A quantum-resistant cryptographic module produces attestation evidence and signatures using post-quantum algorithms. Inter-agent communication occurs over attested channels carrying zero-knowledge intermediate proofs. A hardware-rooted consensus engine determines acceptance of generated code based on attestation evidence, formal verification results, and agent outputs. A tamper-resistant provenance ledger records the full history of generation, verification, consensus, deployment, and feedback.

Technical advantages include: (i) mathematically provable correctness of generated code; (ii) post-quantum cryptographic durability of attestation and signatures; (iii) hardware-rooted, attestation-backed validator identity for Byzantine consensus; (iv) confidentiality of inter-agent reasoning via zero-knowledge proofs; (v) cross-vendor portability through federated TEE networks; (vi) self-sovereign agent identities resistant to impersonation; (vii) verifiable third-party auditability; (viii) energy-efficient execution through neuromorphic scheduling; (ix) iterative predictive refinement until formal proof success; and (x) machine-enforced safety through alignment-score thresholds and blast-radius containment proofs.

### DEFINITIONS

For the purposes of this disclosure, the following terms have the meanings set forth below. Where a defined term is used in the claims, that definition controls. All other terms have their ordinary meaning to one of ordinary skill in the art at the time of filing.

“Specialized AI Agent” means an AI module configured to perform a discrete function selected from code generation, security analysis, regulatory compliance evaluation, refinement, alignment scoring, reproducibility verification, test or property generation, or independent cross-validation.

“Trusted Execution Environment (TEE)” means a hardware-isolated execution context that protects code, data, and intermediate state from observation or modification by privileged software outside the context, and that produces a hardware-rooted measurement of its software state usable in remote attestation.

“Orchestration Layer” means a component executing within a TEE configured to spawn, measure, attest, schedule, and coordinate one or more specialized AI agents.

“Hardware-Rooted Consensus” means a consensus protocol in which the identity, eligibility, and weight of each participating validator are bound to cryptographic attestation evidence produced by one or more TEEs.

“Formal Verification” means a process of mathematically proving one or more properties of code using one or more of: a satisfiability modulo theories (SMT) solver, a theorem prover, a model checker, or a Hoare-logic assertion engine.

“Hoare-Logic Assertion” means a triple specifying a precondition, a program, and a postcondition, the validity of which is mechanically checkable.

“Attested Artifact” means a data object cryptographically bound to a TEE measurement and to an agent identity by a digital signature.

“Quantum-Resistant Cryptography” means cryptographic algorithms believed to be secure against attack by a sufficiently capable quantum computer, including without limitation lattice-based schemes such as ML-DSA (Dilithium), ML-KEM (Kyber), hash-based schemes such as SLH-DSA (SPHINCS+), and FN-DSA (Falcon).

“Self-Sovereign Agent Identity” means a decentralized identifier (DID) for an AI agent, the control of which is bound by cryptographic linkage to hardware attestation evidence of the TEE in which the agent executes.

“Zero-Knowledge Intermediate Proof” means a cryptographic proof exchanged between agents that demonstrates correct computation or possession of a property without revealing the underlying inputs, intermediate states, or sensitive details.

“Federated TEE Network” means two or more TEEs, optionally provided by different hardware vendors, mutually attested and connected by authenticated, confidential channels supporting collaborative computation across trust domains.

“AI Alignment Score” means a quantitative metric computed for a generated artifact reflecting adherence to one or more of safety, ethical, organizational, regulatory, or policy criteria.

“Neuromorphic Scheduling” means a scheduling policy that allocates AI and verification workloads to hardware accelerators-including neuromorphic, spiking, tensor-streaming, or low-precision accelerators-based on workload characteristics and energy-efficiency objectives.

“Refinement Loop” means an iterative process in which generated code is repeatedly modified by one or more specialized AI agents in response to formal verification feedback until defined success criteria are satisfied or a bounded number of iterations is reached.

“Blast-Radius Containment” means a formally proven property bounding the scope of state, resources, or systems affected by execution of code, including without limitation memory regions, network destinations, file paths, capabilities, or external services.

“Consensus Threshold” means a policy-defined minimum quantity, weight, or proportion of agreeing validators required for the consensus engine to accept a generated artifact.

### BRIEF DESCRIPTION OF THE DRAWINGS

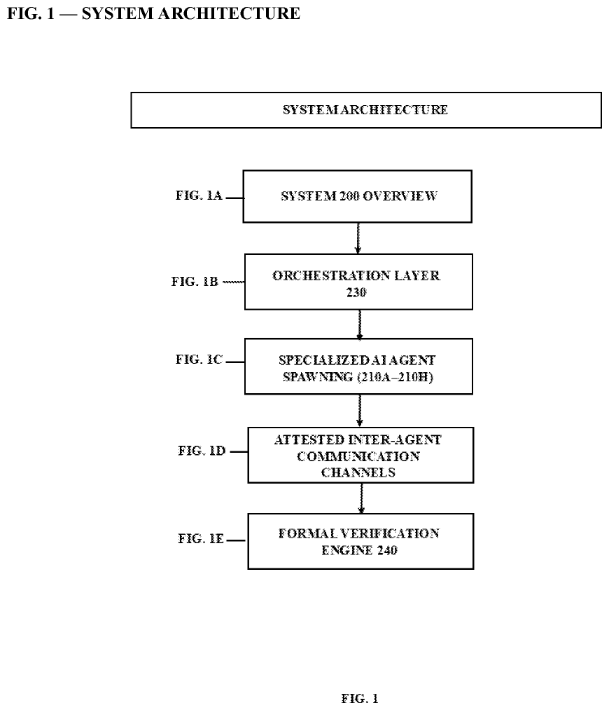

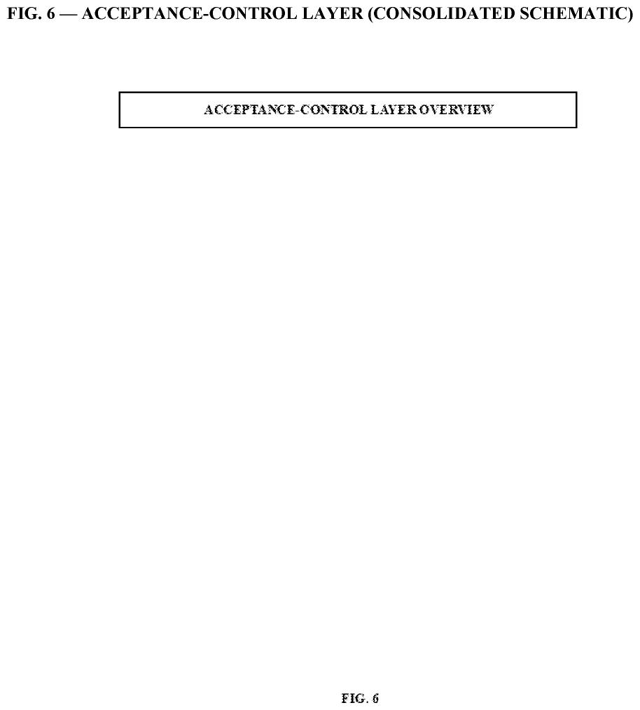

The disclosure is described with reference to FIGS. 1 through 5, each comprising five sub-figures (A through E), and to FIG. 6, which is a consolidated schematic flow diagram of the acceptance-control layer architecture disclosed herein. Identical or analogous elements are denoted by identical reference numerals throughout. The figures are schematic and not drawn to scale.

### FIG. 1—System Architecture

FIG. 1A is a schematic block diagram of system 200 showing inputs 202, outputs 204, specialized AI agents 210, federated TEE network 220, orchestration layer 230, formal verification engine 240, quantum-resistant cryptographic module 250, zero-knowledge proof module 260, hardware-rooted consensus engine 270, provenance ledger 280, alignment scoring engine 290, and third-party verifier interface 296.

FIG. 1B is a schematic block diagram of orchestration layer 230, depicting agent spawning module 232, dynamic spawning logic 234 responsive to input complexity, formal verification failure rate, and alignment score, neuromorphic scheduler 236, and agent attestation evidence 216.

FIG. 1C is a schematic block diagram of agent spawning, depicting instantiation of specialized AI agents 210a (code generation), 210b (security analysis), 210c (regulatory compliance), 210d (refinement), 210e (alignment scoring), 210f (reproducibility), 210g (independent secondary AI cross-check), and 210h (test/property generation), each provisioned with a self-sovereign agent identity 214.

FIG. 1D is a schematic block diagram of attested communication channels 228 connecting specialized AI agents 210 across federated TEE network 220 with mutual remote attestation, post-quantum encryption, and zero-knowledge intermediate proofs 262.

FIG. 1E is a schematic block diagram of formal verification engine 240, depicting SMT solver 242, theorem prover 244, model checker 246, Hoare-logic assertion module 248, and blast-radius containment proof module 249.

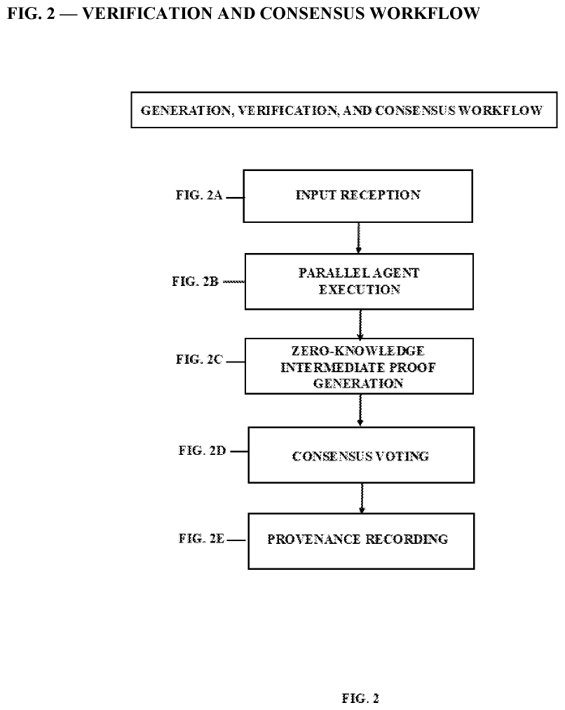

### FIG. 2—Generation, Verification, and Consensus Workflow

FIG. 2A is a flow diagram of input reception, depicting receipt of prompts 202a, structured specifications 202b, policy references 202c, target runtime identifiers 202d, and formal-specification annotations 202e via attested I/O channel 228.

FIG. 2B is a flow diagram of parallel agent execution, depicting concurrent operation of specialized AI agents 210a-210h within federated TEE network 220, exchange of intermediate states via channel 228 and proofs 262, and emission of candidate code, validation outputs, and proofs.

FIG. 2C is a flow diagram of zero-knowledge intermediate proof generation by zero-knowledge proof module 260, depicting agents demonstrating correct computation, possession of properties, or constraint satisfaction without revealing inputs or internal states.

FIG. 2D is a flow diagram of consensus voting, depicting hardware-rooted consensus engine 270 weighting validator inputs by attestation evidence 216 and agent performance history 218, applying Byzantine fault-tolerant voting 272, evaluating consensus threshold 274, and applying override and escalation rules 276.

FIG. 2E is a flow diagram of provenance recording, depicting submission of inputs, generated code, attestation evidence, formal verification results, zero-knowledge proofs, consensus decisions, and runtime signals to provenance ledger 280 as ledger entries 282 linked into hash chain 284 and aggregated into Merkle root 286 anchored to public-chain anchor 288.

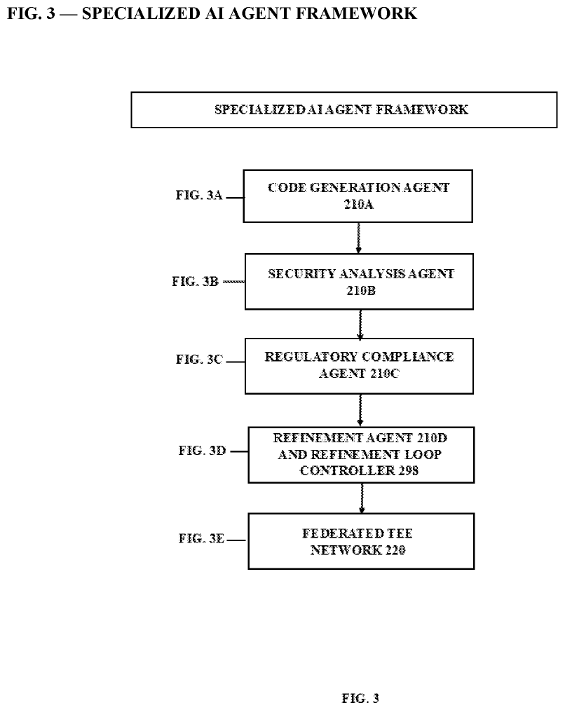

### FIG. 3—Specialized AI Agent Framework

FIG. 3A is a schematic block diagram of code generation agent 210a, depicting receipt of inputs 202, model parameters under attestation, sampling parameters, and emission of candidate code accompanied by attested artifact 216.

FIG. 3B is a schematic block diagram of security analysis agent 210b, depicting application of CWE/CVE pattern matching, taint analysis, exploitability scoring, and supplemental formal verification of security-critical invariants by SMT solver 242.

FIG. 3C is a schematic block diagram of regulatory compliance agent 210c, depicting policy ruleset interpretation in machine-readable language (OPA Rego, Cedar, XACML) covering HIPAA, GDPR, PCI-DSS, 21 C.F.R. Part 11, SOX, FedRAMP, ISO/IEC 27001, DO-178C, IEC 62304, MiFID II, and Basel III/IV rules.

FIG. 3D is a schematic block diagram of refinement agent 210d operating within refinement loop controller 298, depicting iterative modification of candidate code in response to formal verification feedback until defined success criteria are met or a bounded number of iterations is reached.

FIG. 3E is a schematic block diagram of federated TEE network 220 spanning Intel SGX 220a, Intel TDX 220b, AMD SEV-SNP 220c, ARM TrustZone 220d, ARM CCA 220e, AWS Nitro Enclaves 220f, Azure Confidential VM 220g, GCP Confidential VM 220h, and NVIDIA confidential GPU 220i, with cross-trust-domain bridge 299.

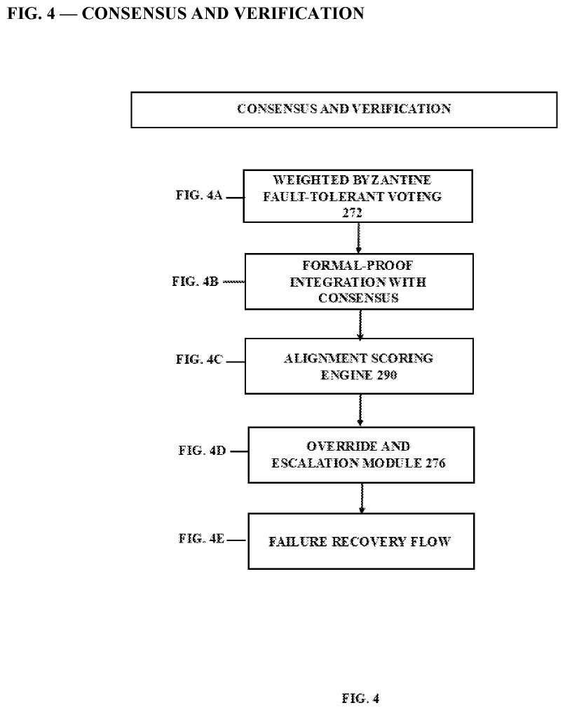

### FIG. 4—Consensus and Verification

FIG. 4A is a schematic block diagram of weighted Byzantine fault-tolerant voting 272, depicting weight assignment by agent role, attestation freshness, and agent performance history 218, with quorum thresholds and proof-of-vote signatures using post-quantum signature module 252.

FIG. 4B is a schematic block diagram of formal-proof integration with consensus, depicting the requirement that formal verification engine 240 produce a valid proof satisfying defined safety and functional properties before consensus engine 270 may accept the generated artifact.

FIG. 4C is a schematic block diagram of alignment scoring engine 290, depicting computation of alignment score 292 across one or more dimensions of safety, ethical, organizational, and policy adherence, and rejection of artifacts below alignment threshold 294.

FIG. 4D is a schematic block diagram of override and escalation module 276, depicting deterministic rejection in response to specified validation outputs (e.g., critical CWE finding, alignment score below threshold) regardless of other agent verdicts, and deterministic escalation to human review under defined conditions.

FIG. 4E is a flow diagram of failure recovery, depicting branch behavior on consensus failure: rollback of any provisional state, recording of failure entry in ledger 280, optional re-spawning of additional agents by dynamic spawning logic 234, and re-execution of refinement loop 298 within bounded iteration limits.

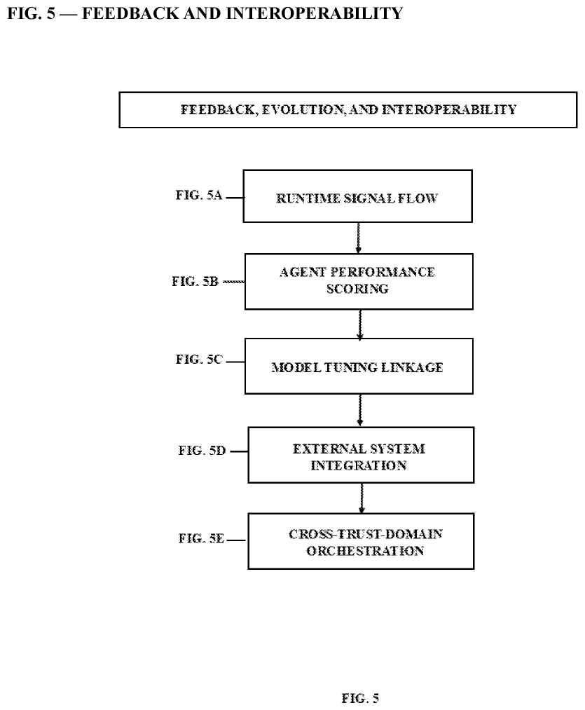

### FIG. 5—Feedback, Evolution, and Interoperability

FIG. 5A is a schematic block diagram of runtime signal flow, depicting collection of post-deployment telemetry, anomaly indicators, and policy-deviation events from deployed code, and routing of such signals to ledger 280 and to the feedback subsystem associated with code generation agent 210a.

FIG. 5B is a schematic block diagram of agent performance scoring, depicting accumulation of agent performance history 218 from validation outcomes, formal verification successes and failures, and consensus participation, and use thereof in voting weight computation.

FIG. 5C is a schematic block diagram of model tuning linkage, depicting return of validation, consensus, alignment, and runtime signals to model training and fine-tuning infrastructure for code generation agent 210a, including reinforcement learning from validator feedback (RLVF) and retrieval-index updates.

FIG. 5D is a schematic block diagram of external system integration, depicting application programming interfaces enabling system 200 to exchange policy artifacts, provenance entries, and attestation evidence with one or more external policy enforcement engines, provenance ledgers, runtime attestation systems, insurance underwriting systems, capital reserve calculation systems, and enterprise risk management systems.

FIG. 5E is a schematic block diagram of cross-trust-domain orchestration, depicting bridge 299 enabling federated execution and unified verification of artifacts produced collaboratively by agents across heterogeneous TEEs 220a-220i, with mutual attestation and post-quantum-secured channels.

### DETAILED DESCRIPTION OF THE PREFERRED EMBODIMENTS

The following description sets forth specific details to provide a thorough understanding of various embodiments. One of ordinary skill in the art will appreciate that the disclosed embodiments may be practiced without one or more specific details and that variations and modifications are possible without departing from the scope of the disclosure. Where a term is defined herein, that definition controls; where a term is not defined, it is given its ordinary meaning to one of ordinary skill in the art at the time of filing.

### System Architecture (FIG. 1A)

Referring to FIG. 1A, system 200 comprises specialized AI agents 210, federated TEE network 220, orchestration layer 230 within at least one TEE, formal verification engine 240, quantum-resistant cryptographic module 250, zero-knowledge proof module 260, hardware-rooted consensus engine 270, provenance ledger 280, alignment scoring engine 290, third-party verifier interface 296, refinement loop controller 298, and cross-trust-domain bridge 299. Inputs 202 may comprise prompts 202a, structured specifications 202b, policy references 202c, target runtime identifiers 202d, and formal-specification annotations 202e (including pre/post-conditions, invariants, and temporal-logic safety properties). Outputs 204 may comprise generated code 204a, formal-verification proofs 204b, attested artifacts 204c, zero-knowledge proofs 204d, and consensus records 204e.

### Federated TEE Network (FIG. 3E)

Federated TEE network 220 comprises one or more TEEs, optionally from heterogeneous hardware vendors, including Intel SGX 220a, Intel TDX 220b, AMD SEV-SNP 220c, ARM TrustZone 220d, ARM CCA 220e, AWS Nitro Enclaves 220f, Azure Confidential VMs 220g, Google Cloud Confidential VMs 220h, and NVIDIA confidential GPU 220i. Each TEE produces a hardware-rooted measurement 222 derived from a hardware root of trust 224, maintains a sealed key store 226 binding keys to measurement 222, and exposes attested I/O channel 228 carrying authenticated, confidential traffic. Cross-trust-domain bridge 299 enables mutually attested communication between TEEs across vendor and trust boundaries; bridge 299 may implement remote attestation conformant with the IETF Remote Attestation Procedures (RATS) framework, DICE attestation, or TPM 2.0 quote semantics.

### Orchestration Layer and Dynamic Spawning (FIG. 1B, FIG. 1C)

Orchestration layer 230 executes within at least one TEE and comprises agent spawning module 232 and dynamic spawning logic 234. Module 232 instantiates specialized AI agents 210 within the same or different TEEs, measures each agent prior to execution, and provisions each agent with a self-sovereign agent identity 214 cryptographically linked to attestation evidence 216 of the TEE in which the agent executes. Logic 234 dynamically spawns additional agents in response to at least one of: (a) input complexity exceeding a threshold; (b) formal verification failure rate exceeding a threshold; (c) alignment score 292 below alignment threshold 294; (d) consensus engine 270 failing to reach consensus threshold 274; or (e) administrator policy. Neuromorphic scheduler 236 allocates verification, generation, and consensus workloads to compute resources—including neuromorphic, spiking, tensor-streaming, low-precision, and conventional accelerators—based on workload characteristics and energy-efficiency objectives.

### Specialized AI Agents (FIG. 3A-3D)

Specialized AI agents 210 comprise, in various embodiments: code generation agent 210a (e.g., a transformer-based large language model, a diffusion model, a state-space model, a retrieval-augmented generation system, an ensemble, or a tool-using agent); security analysis agent 210b applying CWE and CVE signatures, taint analysis, control-flow analysis, and supplemental formal verification of security invariants; regulatory compliance agent 210c applying machine-readable rules in OPA Rego, Cedar, XACML, or a domain-specific language; refinement agent 210d operating within refinement loop controller 298; alignment scoring agent 210e computing alignment score 292; reproducibility agent 210f re-executing code generation under recorded sampling parameters; independent secondary AI cross-check agent 210g comprising a second AI model independent of agent 210a to reduce common-mode failure; and test/property generation agent 210h producing test cases and formal-specification properties. In some embodiments, additional specialized agents may include a fuzz-testing agent, a license compliance agent applying SPDX-formatted policies, and an intellectual-property-conflict agent.

### Self-Sovereign Agent Identity

Each specialized AI agent 210 is provisioned with a self-sovereign agent identity 214 comprising a decentralized identifier (DID), a verifiable credential set, and a public key. The private key associated with identity 214 is sealed within the TEE and bound to measurement 222 such that the agent can produce signatures only when executing within an authorized TEE state. Identities 214 may be registered to a federated identity registry, a permissioned distributed ledger, or a public verifiable data registry. Verifiable credentials may attest to agent role, training provenance, evaluation results, and policy authorizations.

### Formal Verification Engine (FIG. 1E, FIG. 4B)

Formal verification engine 240 executes within at least one TEE and computes mathematical proofs of properties of generated code in real time or within bounded iterations during multi-agent collaboration. Engine 240 comprises SMT solver 242 (e.g., Z3, CVC5, Yices, or MathSAT), theorem prover 244 (e.g., Coq, Lean, Isabelle/HOL, F*, ACL2, or Agda), model checker 246 (e.g., TLA+, SPIN, NuSMV, mCRL2, or UPPAAL), Hoare-logic assertion module 248, and blast-radius containment proof module 249. Properties proven include functional correctness against pre/post-conditions, type-safety, memory-safety, race-freedom, termination or bounded termination, absence of specified vulnerability classes, conformance to temporal-logic safety and liveness specifications, and bounded blast radius (e.g., proven absence of writes outside a specified memory region or network calls outside a specified destination set). Proofs are themselves attested artifacts and may be accompanied by machine-checkable proof certificates.

### Quantum-Resistant Cryptographic Module (FIG. 1A)

Quantum-resistant cryptographic module 250 produces post-quantum signatures and key encapsulations for attestation evidence 216, attested artifacts, inter-agent communications, and consensus votes. In various embodiments, module 250 implements ML-DSA (Dilithium) 252, ML-KEM (Kyber) 254, FN-DSA (Falcon) 256, SLH-DSA (SPHINCS+) 258, or hybrid constructions combining a classical and a post-quantum algorithm. Module 250 may further support post-quantum-secure variants of TLS, Noise, and similar transport protocols.

### Zero-Knowledge Inter-Agent Communication (FIG. 1D, FIG. 2C)

Zero-knowledge proof module 260 produces zero-knowledge intermediate proofs 262 by which one specialized AI agent demonstrates to another (or to consensus engine 270) the correctness of a computation, possession of a property, or satisfaction of a constraint, without revealing underlying inputs, intermediate states, or model internals. In various embodiments, module 260 implements zk-SNARKs (e.g., Groth16, PLONK, Marlin), zk-STARKs, Bulletproofs, or interactive proofs. Proofs 262 are recorded in ledger 280 to enable third-party verification.

### Hardware-Rooted Consensus (FIG. 2D, FIG. 4A)

Hardware-rooted consensus engine 270 produces a consensus decision regarding acceptance of generated code based on (i) attestation evidence 216 of participating agents, (ii) results of formal verification engine 240, (iii) alignment score 292 relative to alignment threshold 294, and (iv) outputs of specialized AI agents 210. Voting module 272 implements weighted Byzantine fault-tolerant voting, with weights derived from agent role, attestation freshness, and agent performance history 218. Consensus threshold 274 may be a configurable quantity, weight, or proportion. Override and escalation module 276 enforces deterministic rejection or escalation in response to specified validation outputs irrespective of other verdicts. Votes are signed by post-quantum signature module 252 and recorded in ledger 280.

### Tamper-Resistant Provenance Ledger (FIG. 2E)

Provenance ledger 280 records, in tamper-resistant form, ledger entries 282 corresponding to inputs 202, generated code 204a, attested artifacts 204c, formal verification results 204b, zero-knowledge proofs 204d, consensus records 204e, alignment scores 292, runtime signals, and feedback. Ledger 280 may comprise a permissioned distributed ledger (e.g., Hyperledger Fabric), a hash-chained append-only log 284, a Merkle-tree-anchored log 286 with periodic anchoring of root 286 to public-chain anchor 288 (e.g., Bitcoin or Ethereum), or an audit database with cryptographic integrity. Third-party verifier interface 296 enables an entity independent of an operator of system 200 to verify attestation evidence, formal-verification proofs, consensus records, and ledger entries with proof-of-inclusion.

### Alignment Scoring Engine (FIG. 4C)

Alignment scoring engine 290 computes alignment score 292 reflecting adherence of a generated artifact to one or more dimensions including safety, ethical conformance, organizational policy, and regulatory rules. In various embodiments, engine 290 derives score 292 from validation outputs, alignment-specific evaluations performed by alignment scoring agent 210e, model-internal uncertainty estimates, and reference comparisons to approved exemplars. Artifacts with score 292 below alignment threshold 294 are deterministically rejected by override module 276.

### Refinement Loop Controller (FIG. 3D)

Refinement loop controller 298 coordinates iterative modification of candidate code by refinement agent 210d in response to feedback from formal verification engine 240, validation agents 210b-210h, and alignment scoring engine 290. Each iteration produces an updated candidate, attested artifact, and formal-verification result. The loop terminates upon (a) successful formal verification meeting all defined properties, (b) exhaustion of a bounded iteration count, or (c) administrator-defined abort conditions. Each iteration is recorded in ledger 280.

### Failure Recovery (FIG. 4E)

On failure of consensus, formal verification, or alignment, system 200 records a failure entry in ledger 280, rolls back any provisional state, optionally invokes dynamic spawning logic 234 to instantiate additional agents (including agents from independent model families), and may re-execute refinement loop controller 298 within bounded limits. Repeated failure may trigger deterministic escalation to human review by override module 276.

### External System Integration (FIG. 5D)

System 200 exposes a defined application programming interface enabling exchange of policy artifacts, provenance entries, and attestation evidence with external systems including, without limitation, external policy enforcement engines, external provenance ledgers, runtime attestation systems, insurance underwriting platforms, capital reserve calculation engines, enterprise risk management systems, and regulatory reporting systems. Integration occurs via authenticated, post-quantum-secured channels, and exchanged artifacts retain their attestation evidence to enable end-to-end verification by downstream parties.

### Enablement Example 1: Healthcare Software as a Medical Device (SaMD) Embodiment

In a healthcare embodiment, system 200 generates clinical decision support software or Software as a Medical Device (SaMD) code for electronic health record integration. AWS Nitro Enclave 220f hosts orchestration layer 230. Regulatory compliance agent 210c applies HIPAA, FDA 21 C.F.R. Part 11, and IEC 62304 rules in machine-readable form. Formal verification engine 240 mathematically proves invariants required for SaMD certification, including patient-data containment (blast-radius containment), audit-log integrity, and absence of unauthorized data exfiltration. Alignment scoring engine 290 reports patient-safety exposure to a quality management system. Provenance ledger 280 supplies regulator-grade audit evidence. All generated code is accepted only after formal proof of safety properties and consensus among at least three TEEs of federated TEE network 220.

### Enablement Example 2: Defense and Aerospace—DO-178C Level A Embodiment

In a defense and aerospace embodiment, federated TEE network 220 spans Intel TDX 220b and AMD SEV-SNP 220c. System 200 produces flight-control or mission-system code conformant to DO-178C Level A using Hoare-logic assertions and model checking with model checker 246. Self-sovereign agent identities 214 are verifiable by the mission authority. Consensus engine 270 is configured for unanimous approval across heterogeneous TEEs. Cross-trust-domain bridge 299 supports classified-handling controls. Blast-radius containment proofs produced by module 249 ensure no unintended interaction with flight-critical subsystems. Runtime telemetry is fed back via ledger 280 into refinement loop controller 298 for continuous improvement while maintaining formal guarantees.

The healthcare and defense embodiments of Enablement Examples 1 and 2 illustrate two regulated-industry deployments of the disclosed system. The elements common to both—formal verification within a hardware-attested trusted execution environment, hardware-rooted consensus among AI-agent validators, post-quantum-attested provenance, and a transferable verification artifact—are the elements that confer the technological improvement disclosed herein and are not specific to either regulated domain. The proof obligations discharged by formal verification engine 240 differ between the examples (e.g., patient-data containment versus flight-critical subsystem isolation), but the gating architecture, the cryptographic binding, and the recording in provenance ledger 280 do not differ.

The disclosed system is not limited to the regulated domains exemplified above; further embodiments adapted to financial services, critical-infrastructure control systems, decentralized smart-contract platforms, autonomous-vehicle software, industrial-control systems, energy-grid management systems, and other high-assurance domains are within the scope of the present disclosure. In each such embodiment the proof obligations of formal verification engine 240 are configured per domain, the validator quorum of hardware-rooted consensus engine 270 is configured per applicable governance regime, and the anchoring schedule of provenance ledger 280 is configured per applicable recordkeeping requirements. In one commercial embodiment, artificial-intelligence-generated software code intended for deployment to a regulated enterprise production environment is blocked from such deployment until and unless the hardware-enforced deployment gate transitions from BLOCKED to OPEN upon simultaneous satisfaction of all four gating conditions described in paragraph [0097]; in such commercial embodiment, the transferable proof-and-attestation package described elsewhere herein constitutes the audit-grade evidence relied upon by the enterprise's compliance, risk-management, and external-audit functions as the record of acceptance.

### VARIATIONS AND EQUIVALENTS

Components of system 200 may be combined, separated, distributed, or duplicated. Functions described as performed by a single component may be performed by multiple components, and vice versa. Communications between components are encrypted, authenticated, and signed using post-quantum primitives. Components may execute on the same physical machine, on multiple machines within a single trust domain, or across multiple trust domains connected through attested channels. Although embodiments are described in connection with code generation, the disclosed architecture is applicable to other AI-generated artifacts including configuration files, infrastructure-as-code definitions, machine-learning model weights, schemas, contracts, regulatory filings, and structured documents requiring verifiable provenance and post-quantum durability. Recitations of “comprising” are open-ended; “one or more,” “a plurality of,” and “at least one” are non-limiting; and section headings are for convenience only. The scope of the present disclosure is not limited to the embodiments described herein but is defined solely by the claims and their legal equivalents.

### Summary of the Inventive Concept—Acceptance-Control Layer for AI-Generated Code

Disclosed is an acceptance-control layer for artificial-intelligence-generated software code: an integrated computer architecture interposing a unified decision boundary between AI generation and downstream deployment, such that candidate code is admitted to downstream consumption only upon satisfaction of machine-checkable, hardware-attributable, post-quantum-durable, and tamper-evidently recorded gating conditions. FIG. 6 depicts, at a single glance, the four gating conditions and the structural relationship by which the acceptance-control layer effectuates this decision boundary. The technical problem addressed by the present disclosure is the absence of a unified architecture in conventional tooling: AI code generation, formal verification, confidential computing, blockchain provenance, and Byzantine consensus each address a portion of the trust gap presented by AI-generated code, but each conventionally operates as an isolated capability that admits AI-generated code into downstream systems without machine-checked correctness, without hardware-rooted attribution, without post-quantum durability, and without tamper-evident audit-grade gating.

The acceptance-control layer disclosed herein is realized through the integration of (i) a multi-agent AI architecture in which each specialized AI agent executes within a measured trusted execution environment (TEE), (ii) a formal verification engine integrated within the multi-agent generation loop and operating in real time or within bounded iterations, (iii) a hardware-rooted Byzantine consensus engine binding validator eligibility to TEE attestation evidence, (iv) a quantum-resistant cryptographic module producing post-quantum signatures and attestations, (v) zero-knowledge intermediate proofs as the basis for inter-agent communication, and (vi) a tamper-resistant provenance ledger anchoring the full generation, verification, and consensus history. Together, these components constitute the acceptance-control layer. The unified result is a verifiable, attributable, post-quantum-durable code artifact whose properties can be independently confirmed by a third party. The acceptance-control layer is rooted in computer technology, addresses a problem arising specifically from the operation of AI code generation in regulated and adversarial environments, and improves the functioning of the computer system itself by reducing acceptance of code lacking provable correctness properties and by reducing the attack surface presented to compromised software components outside the TEE.

### Advantages of the Acceptance-Control Layer Over Existing Approaches

Existing approaches addressing subsets of the technical problem addressed by the disclosed acceptance-control layer suffer from one or more limitations that the layer overcomes. Approaches relying on confidential AI inference within a single TEE provide attestation of the inference computation but do not gate code acceptance on machine-checked correctness, do not produce a cross-vendor attested artifact, and rely on classical signature schemes vulnerable to harvest-now-decrypt-later attack. Approaches relying on post-hoc formal verification operate as a separate offline workflow and do not integrate within the multi-agent generation loop, foreclosing real-time refinement against verification feedback. Approaches relying on multi-agent AI orchestration provide redundancy and specialization but do not bind agent identity to hardware attestation and do not produce a unified verifiable artifact. Approaches relying on blockchain-anchored provenance establish ledger immutability but do not bind ledger entries to TEE-attested execution and do not bring formal verification within the trusted boundary. The acceptance-control layer disclosed herein differs in that the components are integrated into a single architecture in which (i) formal verification operates contemporaneously with multi-agent generation, (ii) consensus eligibility is hardware-bound, (iii) all inter-agent communications and attestations are post-quantum-secured, (iv) inter-agent state is communicated by zero-knowledge proof rather than disclosure, and (v) the federated TEE network produces a single attested artifact across heterogeneous vendor trust domains. The principal advantages of the disclosed acceptance-control layer are summarized in tabular form below; each row identifies an advantage, the architectural element by which the advantage is realized, and the technical benefit produced.

| Advantage | Realized by the Disclosed Architecture | Technical Benefit |
|---|---|---|
| Machine-checked | Formal verification engine within TEE | Structurally prevents transmission of code |
| correctness | producing a machine-checkable proof | lacking machine-checked correctness |
| | | properties |
| Hardware-bound | Attestation evidence sealed to the | Prevents impersonation of AI agents and |
| validator identity | hardware-rooted TEE measurement | binds consensus eligibility to hardware |
| Post-quantum | ML-DSA, ML-KEM, FN-DSA, and | Produces an audit record durable against |
| cryptographic | SLH-DSA signatures/KEMs | future cryptanalytic attack by quantum |
| durability | | computers |
| Tamper-evident | Provenance ledger with Merkle roots | Enables independent third-party verification |
| audit trail | anchored to a public blockchain | without reliance on the operator |
| Cross-vendor | Federated TEE network across | Avoids single-vendor lock-in and supports |
| portability | heterogeneous hardware vendors with | multi-cloud regulated deployments |
| | RATS/EAT handshake | |
| Inter-agent | Zero-knowledge intermediate proofs | Protects model internals and intermediate |
| confidentiality | between specialized AI agents | states from disclosure across the agent fabric |
| Iterative | Bounded refinement loop with | Converges on correctness within |
| correctness | counterexample-driven feedback | deterministic resource bounds with auditable |
| improvement | | termination state |
| Single licensable | Transferable proof-and-attestation | Enables independent verification by |
| artifact | package (header/body/trailer | regulators, insurers, exchanges, and |
| | structure) | counterparties |

### Algorithmic Implementation Details

### Refinement Loop Controller—Operational Logic

In one embodiment, refinement loop controller 298 of FIG. 3D operates according to the following pseudocode logic, expressing a bounded iterative process consistent with the description in paragraph [0064]:

```
function refinement_loop(input, agents, properties, max_iter):
  candidate := agents.code_gen.generate(input)
  artifact := pqc.attest(candidate,
agents.code_gen.tee_measurement)
  ledger.append(“iter_0”, candidate, artifact)
  for i in 1..max_iter:
    proof := formal_verify.run(candidate, properties)
    ledger.append(“iter_” + i, proof, artifact)
    if proof.satisfies_all(properties):
      return ACCEPT(candidate, proof, artifact)
  feedback := formal_verify.diagnose(candidate, proof)
  candidate := agents.refinement.modify(candidate,
feedback)
    artifact := pqc.attest(candidate,
agents.refinement.tee_measurement)
  return REJECT(“max_iter_exceeded”, last_proof, artifact)
```

where the call “pqc.attest” is performed by quantum-resistant cryptographic module 250, the call “formal_verify.run” is dispatched by formal verification engine 240 to one or more of SMT solver 242, theorem prover 244, model checker 246, or Hoare-logic assertion module 248, and “ledger.append” writes a tamper-evident entry to provenance ledger 280.

### Weighted Byzantine Voting—Operational Logic

In one embodiment, voting module 272 of FIG. 4A computes the consensus decision according to the following pseudocode logic, consistent with paragraph [0061]:

| function consensus(votes, agents, threshold): | |
|---|---|
| accepted := 0; rejected := 0; total_weight := 0 | |
| for v in votes: | |
| if not pqc.verify_signature(v.signature, v.agent_did): | |
| continue | // discard |
| unverifiable vote | |
| if not attestation_fresh(v.agent_attestation): | |
| continue | // discard stale |
| attestation | |
| w := weight(v.agent.role, | |
| freshness(v.agent_attestation), | |
| history(v.agent.performance)) | |
| total_weight += w | |
| if v.decision == ACCEPT: accepted += w | |
| else: rejected += w | |
| if override.triggered(votes): | // critical |

```
CWE, alignment fail
    return DETERMINISTIC_REJECT
  if accepted / total_weight >= threshold: return ACCEPT
  return REJECT
```

The function “weight” may be a configurable function of agent role, attestation freshness, and prior validation accuracy; the function “override.triggered” enforces deterministic rejection in response to specified validation outputs (e.g., a critical CWE finding by security analysis agent 210b or an alignment score 292 below threshold 294) regardless of weighted vote totals, as described in paragraph [0061].

### Zero-Knowledge Intermediate Proof Generation-Operational Logic

In one embodiment, zero-knowledge proof module 260 of FIG. 1D and FIG. 2C operates according to the following pseudocode logic, consistent with paragraph [0060]:

```
function zk_intermediate_proof(prover_agent, statement,
witness):
  // statement: assertion provable about hidden witness
  // witness: model-internal data, sampling, or
intermediate state
  proving_key := zk.setup(statement.circuit_id)
  pi := zk.prove(proving_key, statement, witness) // e.g.
Groth16/PLONK/STARK
  pqc_sig := pqc.sign(pi || prover_agent.tee_measurement,
    prover_agent.sealed_key)
  return ZkArtifact(statement, pi, pqc_sig,
prover_agent.did)
function zk_intermediate_verify(verifier_agent, artifact):
  if not pqc.verify(artifact.pqc_sig, artifact.did): return
REJECT
  if not attestation_valid(artifact.did): return REJECT
  return zk.verify(artifact.statement, artifact.pi)
```

The combination of post-quantum signature with the underlying ZK proof preserves both confidentiality of the witness (e.g., model parameters, sampling temperature, intermediate activations) and post-quantum durability of the proof attribution chain. Verified ZK artifacts are recorded in provenance ledger 280 to enable later third-party verification.

### Alignment Score Computation-Operational Logic

In one embodiment, alignment scoring engine 290 of FIG. 4C computes alignment score 292 according to the following pseudocode logic, consistent with paragraphs and

```
function alignment_score(artifact, dimensions, weights):
  // dimensions: list of {safety, ethical, organizational,
regulatory, ... }
  // weights: sum to 1.0
  sub_scores := { }
  for d in dimensions:
    sub_scores[d] := evaluate(artifact, d.evaluator,
d.criteria)
  score := sum(weights[d] * sub_scores[d] for d in
dimensions)
  return score, sub_scores
function alignment_gate(score, sub_scores, threshold,
hard_gates):
  for g in hard_gates:
    if sub_scores[g.dimension] < g.minimum:
      return DETERMINISTIC_REJECT(g) // any single
hard-gate fail → reject
  if score < threshold: return REJECT(“sub_threshold”)
  return ACCEPT
```

The function “evaluate” may be implemented by alignment scoring agent 210e using one or more of policy rule evaluation, model-internal uncertainty estimation, and reference comparison to approved exemplars. The hard-gate mechanism implements the deterministic rejection behavior described in paragraph for designated dimensions (e.g., a minimum patient-safety sub-score in healthcare embodiments).

### Blast-Radius Containment Proof—Operational Logic

In one embodiment, blast-radius containment proof module 249 of FIG. 1E proves a bounded blast-radius property according to the following pseudocode logic, consistent with paragraphs and [0058]:

| function prove_blast_radius(code, allowed): | |
|---|---|
| // allowed: {memory_regions, network_destinations, | |
| file_paths, capabilities} | |
| cfg := build_control_flow_graph(code) | |
| eff := compute_effect_set(cfg) | // memory |
| writes, syscalls, net I/O | |
| obligations := [ ] | |
| for e in eff: | |
| obligations.append(forall_inputs(e.target in | |
| allowed[e.kind])) | |
| proof := smt.discharge(obligations) | // or theorem |
| prover / model checker | |
| if proof.valid: return PROVED(proof) | |
| return COUNTEREXAMPLE(proof.cex) | // returns |

trace into refinement loop

The discharged obligations may include the proven absence of writes outside specified memory regions, network connections to destinations outside an allowed set, file operations on paths outside a permitted root, and invocation of capabilities or syscalls outside an allowed list. Counterexamples returned by the SMT solver, theorem prover, or model checker are passed back to refinement agent 210d as feedback for the next iteration of the refinement loop.

### Provenance Ledger Mechanics

### Merkle Root Construction and Periodic Anchoring

In one embodiment, provenance ledger 280 organizes ledger entries 282 into a Merkle binary tree, computes Merkle root 286 over a configurable batch of entries (e.g., the entries written within a fixed time window or fixed entry count), and anchors root 286 at one or more intervals to public-chain anchor 288. The anchoring transaction commits the Merkle root into a public, immutable medium (e.g., a transaction memo on Bitcoin or a smart contract write on Ethereum), thereby publishing a tamper-evidence baseline against which any subsequent claim of tampering can be checked. The anchoring interval may be selected to balance regulatory recency requirements against transaction cost and may be configured per regulated domain (e.g., daily for financial trading-system audits; per-batch for SaMD release records).

### Proof-of-Inclusion Protocol

In one embodiment, third-party verifier interface 296 supplies a proof of inclusion for any specified ledger entry. Given a target entry e and a published anchor a referencing root R, the proof of inclusion comprises (i) the leaf hash h(e), (ii) the sibling-path hashes from h(e) up to R, and (iii) the public-chain transaction reference for a. The verifier reconstructs R from h(e) and the sibling path, compares the reconstruction against R as published in a, and verifies that a is included in the public chain at or before the relevant audit cut-off. The protocol enables a regulator, customer, insurer, or court-appointed examiner to confirm that a specific input, generated code artifact, attestation, formal-verification result, or consensus decision was recorded prior to a stated time, without reliance on the operator of system 200.

### Quantum-Resistant Migration and Hybrid Constructions

In one embodiment, quantum-resistant cryptographic module 250 produces hybrid signatures and key encapsulations combining a classical algorithm with a post-quantum algorithm so that an attacker must defeat both algorithms to forge attestation evidence. Exemplary, non-limiting hybrid constructions include: (a) ECDSA over P-256 concatenated with ML-DSA (Dilithium) for signatures; (b) X25519 combined with ML-KEM (Kyber) for key establishment; and (c) RSA-3072 concatenated with FN-DSA (Falcon) for legacy-compatibility deployments. Verifiers accept the artifact as valid only if both the classical and the post-quantum components verify successfully. Module 250 supports algorithm negotiation and graceful migration: as additional post-quantum algorithms reach standardization, the negotiation parameters of module 250 may be updated, and re-attestation may be performed for ledger entries created under earlier algorithm sets, preserving long-term verifiability without invalidating the historical record.

### Alignment Dimensions, Weights, and Thresholds

In one embodiment, alignment scoring engine 290 evaluates alignment along dimensions including, without limitation: (i) safety, comprising sub-criteria such as absence of harmful side-effects, bounded resource consumption, and graceful failure behavior; (ii) ethical conformance, comprising sub-criteria such as fairness, non-discrimination, and respect for user autonomy; (iii) organizational policy, comprising sub-criteria such as adherence to internal coding standards, license compliance, and intellectual-property hygiene; and (iv) regulatory compliance, comprising sub-criteria specific to the applicable regulated domain (e.g., HIPAA minimum-necessary disclosure for healthcare; MiFID II best-execution for financial-services trading code). Weights are configurable per deployment and may sum to 1.0; thresholds may be set independently for the aggregate alignment score and for each dimension; and one or more dimensions may be configured as hard-gate dimensions whose failure produces deterministic rejection by override module 276 regardless of the aggregate score, as set forth in paragraph

### Failure Modes and Edge Cases

### Consensus Failure

On failure of consensus engine 270 to reach consensus threshold 274 within a defined time bound or after a defined number of voting rounds, system 200 records a consensus-failure ledger entry, rolls back any provisional state, and may invoke dynamic spawning logic 234 to instantiate one or more additional specialized AI agents (including agents drawn from independent model families) to provide additional independent verdicts. Where independent verdicts continue to disagree past a defined retry budget, override module 276 escalates the artifact to deterministic human review.

### Formal Verification Timeout or Inconclusive Result

On formal-verification timeout, exhaustion of solver resources, or return of an inconclusive result (e.g., “unknown” from an SMT solver), system 200 records the timeout or inconclusive event in ledger 280, decomposes the proof obligation into smaller sub-obligations where decomposable, and re-dispatches the sub-obligations across one or more of SMT solver 242, theorem prover 244, model checker 246, and Hoare-logic assertion module 248. Persistent inconclusivity for a designated property triggers deterministic rejection of the candidate code by override module 276 to prevent acceptance of code whose correctness cannot be established within bounded resources.

### Alignment Threshold Violation

On alignment score 292 falling below alignment threshold 294, or on hard-gate failure on any designated alignment dimension, override module 276 deterministically rejects the candidate code, ledger 280 records the dimension(s) producing the violation, and refinement loop controller 298 may receive the rejection feedback to drive a subsequent iteration. Repeated violation of the same hard-gate across a defined number of iterations triggers escalation to human review and suspension of further automated retries for the inputs in question.

### TEE Attestation Failure or Stale Measurement

On failure to produce a valid TEE attestation, on detection of a measurement that does not match an authorized reference, or on detection of stale attestation evidence outside a configurable freshness window, the affected specialized AI agent is excluded from the consensus decision, its contributions to the current generation cycle are quarantined, and a corresponding entry is written to ledger 280. Where the failure is correlated across multiple TEEs of federated TEE network 220 (suggesting a coordinated platform-level compromise), system 200 may suspend acceptance globally until the federated network is reattested.

### Hardware-Accelerated Formal Verification

In one embodiment, formal verification engine 240 dispatches portions of its workload to dedicated hardware accelerators selected by neuromorphic scheduler 236 from one or more of: a tensor-streaming accelerator configured for matrix-form decision procedures; a field-programmable gate array configured to accelerate specific Boolean-satisfiability or bit-vector decision procedures; a neuromorphic or spiking-neural-network accelerator configured to evaluate alignment heuristics in low-power regimes; and a graphics processing unit operating in a confidential computing mode and configured to parallelize bounded-model-checking workloads. Hardware-accelerated verification reduces wall-clock time of formal-verification iterations within the bounded refinement loop while preserving the cryptographic and attestation properties described herein.

### Tamper-Evident Audit Trails for Regulatory Regimes

Provenance ledger 280, in combination with third-party verifier interface 296, produces audit trails configurable to support compliance recordkeeping under regulated regimes that require electronic records, signed audit logs, attribution to a measured execution context, or tamper-evident provenance. The audit trails do not, by themselves, constitute regulatory compliance; rather, they produce evidence usable by the operator of the system, the regulator, or a designated third-party auditor in establishing compliance with the specific requirements of an applicable regime. By way of three non-limiting examples tied to specific technical steps of the disclosed system: (i) under FDA 21 C.F.R. Part 11, each ledger entry is configurable to serve as an electronic record with the post-quantum signature of the consensus quorum serving as the electronic signature, producing evidence supporting audit-trail integrity, time stamping, and operator attribution; (ii) under DO-178C at Level A criticality, the proof certificates produced by formal verification engine 240 are configurable to serve as objective evidence of verification activities for review by certification authorities, and the ledger entries are configurable to provide reviewable records of verification results; and (iii) under the EU Artificial Intelligence Act for high-risk AI systems, the transferable proof-and-attestation package is configurable to provide the recordkeeping and transparency artifacts used in conformity assessment. Audit trails produced by ledger 280 are further configurable to support compliance recordkeeping under HIPAA, IEC 62304, MiFID II, GDPR, PCI-DSS, SOX, FedRAMP, and Basel III/IV where applicable, with specific configuration of ledger 280 and verifier interface 296 selected per regime requirements.

### External Application Programming Interface Specifications

In one embodiment, system 200 exposes the following representative, non-limiting application programming interfaces, each authenticated by post-quantum signatures and operating over post-quantum-secured transport: (i) a policy-exchange API by which an external policy enforcement engine submits a machine-readable policy ruleset (e.g., OPA Rego, Cedar, XACML) and receives an attested confirmation that the ruleset has been bound into the active configuration of regulatory compliance agent 210c; (ii) a provenance-export API by which an external auditor or regulator retrieves a specified ledger entry together with its proof of inclusion to a published anchor; (iii) an attestation-consumption API by which a runtime attestation system requests fresh attestation evidence for a deployed code artifact; (iv) an underwriting API by which an insurance system requests attested verification reports for use in cyber-insurance underwriting and pricing; (v) a capital-reserve API by which a capital-reserve calculation engine retrieves attestation and verification evidence for purposes of operational-risk capital computation; and (vi) an enterprise-risk API by which an enterprise risk management system retrieves attested change-history records for risk-register maintenance. Each API exposes only the artifacts, signatures, and proofs necessary for the calling system's function and does not disclose model internals or sensitive inputs except as protected by zero-knowledge intermediate proof.

### Detailed Implementation of Enablement Example 1—Healthcare SaMD

In an extended healthcare embodiment, system 200 generates a clinical-decision-support module integrated with an electronic health record system. Orchestration layer 230 hosted within AWS Nitro Enclave 220f spawns code generation agent 210a, security analysis agent 210b, regulatory compliance agent 210c (preloaded with HIPAA, FDA 21 C.F.R. Part 11, and IEC 62304 rulesets in machine-readable form), refinement agent 210d, alignment scoring agent 210e (with a hard gate on patient-safety sub-score), reproducibility agent 210f, and independent secondary cross-check agent 210g (instantiated from a model family independent of agent 210a). Refinement loop controller 298 executes the logic of paragraph [0075]; for each candidate, formal verification engine 240 discharges proof obligations including (a) absence of patient-data writes to destinations outside the configured EHR boundary (a blast-radius containment property under paragraph [0079]), (b) absence of unauthorized data exfiltration over the network, (c) idempotency of clinical-recommendation outputs across reproducibility-agent re-execution under recorded sampling parameters, and (d) audit-log integrity. Consensus engine 270 is configured for at least two-thirds weighted approval across a quorum of at least three TEEs, with deterministic rejection on any critical CWE finding by agent 210b or any patient-safety hard-gate failure by agent 210e. Provenance ledger 280 anchors per-release Merkle roots to a public chain on the schedule of paragraph [0080], producing tamper-evident SaMD release records meeting the recordkeeping requirements of paragraph [0089].

### Detailed Implementation of Enablement Example 2—Defense and Aerospace (DO-178C Level A)

In an extended defense and aerospace embodiment, federated TEE network 220 spans Intel TDX 220b and AMD SEV-SNP 220c with cross-trust-domain bridge 299 implementing IETF RATS-conformant remote attestation. Code generation agent 210a, refinement agent 210d, and an independent secondary cross-check agent 210g operate within the federated network. Formal verification engine 240 dispatches Hoare-logic assertion module 248 and model checker 246 (e.g., SPIN or TLA+) against safety, liveness, and bounded-time-response properties required at DO-178C Level A criticality. Blast-radius containment proof module 249 produces proofs bounding the set of memory regions, hardware registers, and inter-partition communication channels written by the candidate code, ensuring no unintended interaction with flight-critical subsystems. Consensus engine 270 is configured for unanimous approval across the heterogeneous-vendor quorum, with deterministic rejection on any verification timeout or inconclusive result for designated safety properties under paragraph [0085]. Self-sovereign agent identity 214 of each participating agent is verifiable by the mission authority through third-party verifier interface 296. The provenance ledger record, taken with the formal-verification certificates, constitutes a machine-verifiable safety case usable as objective evidence under DO-178C verification objectives.

### Further Variations

The disclosed architecture is applicable to AI-generated artifacts beyond conventional source code, including without limitation: infrastructure-as-code definitions (e.g., Terraform, Pulumi, CloudFormation); container manifests and orchestrator configurations; smart contracts deployable to a public or permissioned blockchain; machine-learning model weights, where the relevant proof obligations may include training-data provenance, dataset compliance, and bounded model-performance properties; structured regulatory filings whose syntactic and semantic correctness can be expressed as formal specifications; and configuration files for safety-critical or compliance-critical control systems. In each case, the proof obligations discharged by formal verification engine 240 are configured to the artifact type, while the multi-agent generation, hardware-rooted consensus, post-quantum attestation, zero-knowledge inter-agent communication, and provenance-ledger mechanisms operate without modification.

No portion of the disclosed system, method, or non-transitory computer-readable medium is intended to be limited to a particular hardware vendor, programming language, formal-verification toolchain, post-quantum cryptographic algorithm, zero-knowledge proof system, consensus protocol, ledger implementation, or alignment scoring methodology, except where such limitation is expressly recited in the appended claims. Equivalents of the disclosed embodiments, including substitutions of functionally equivalent components, recombinations of the disclosed components, and embodiments adapted to artifacts other than software code, are within the scope of the present disclosure.

### Continuation and Divisional Strategy

Applicant reserves the right to file one or more continuation, continuation-in-part, divisional, and foreign counterpart applications claiming subsets, combinations, or extensions of the present disclosure, including without limitation: (i) a continuation directed to integration of refinement loop controller 298 with blast-radius containment proof module 249 as a stand-alone inventive concept; (ii) a continuation directed to federated TEE network 220 in combination with Merkle-anchored provenance ledger 280 and the proof-of-inclusion protocol of paragraph as a stand-alone inventive concept; (iii) a continuation directed to hardware-rooted consensus engine 270 implementing weighted Byzantine fault-tolerant voting 272 with hardware-bound validator identity as a stand-alone inventive concept; (iv) a continuation directed to zero-knowledge proof module 260 producing zero-knowledge intermediate proofs 262 for inter-agent communication as a stand-alone inventive concept; (v) divisional applications adapted to specific regulated domains, including without limitation healthcare Software as a Medical Device, defense and aerospace systems, financial-services trading and risk infrastructure, and critical-infrastructure control systems; and (vi) a continuation directed to hardware-accelerated formal verification under paragraph as a stand-alone inventive concept. The election of any one such application shall not be construed as a disclaimer of the others.

### Prior Art Distinctions

Without naming or admitting the prior-art status of any specific reference, and reserving citation of specific references to the Information Disclosure Statement filed concurrently herewith, the present disclosure is distinguished from each of the following categorical approaches: (a) approaches providing confidential AI inference within a single TEE without integration of formal verification within the generation loop; (b) approaches providing standalone formal-verification tools (SMT solvers, theorem provers, model checkers) operating offline and without hardware-rooted attestation of the verification context; (c) approaches providing multi-agent AI orchestration without binding agent identity to TEE measurement and without consensus eligibility derived from attestation; (d) approaches providing blockchain-anchored audit logs without TEE-attested execution provenance and without formal-verification gating; (e) approaches providing static analysis or fuzz testing as offline pipelines distinct from the generation process; (f) approaches providing classical public-key attestation without quantum-resistant successor algorithms or hybrid post-quantum constructions; (g) approaches providing federated learning over TEEs without cross-vendor mutual attestation and without consensus over verification outputs; and (h) approaches providing AI code-assistant or copilot interfaces without provenance-grade attestation, formal verification, or audit-grade ledger integration. The present disclosure differs from each such approach in that the disclosed components are integrated into a single architecture in which formal verification operates contemporaneously with multi-agent generation, consensus eligibility is hardware-bound, all inter-agent communications and attestations are post-quantum-secured, inter-agent state is communicated by zero-knowledge proof rather than disclosure, and the federated TEE network produces a single attested artifact across heterogeneous vendor trust domains. The integration is itself the inventive concept; no individual element of the integration is claimed in isolation as prior art is preempted only by the combination.

### Acceptance-Control Layer for AI-Generated Code

The integrated architecture disclosed herein constitutes a new acceptance-control layer for artificial-intelligence-generated software code. Conventional AI code generation, conventional formal verification, conventional confidential computing, conventional blockchain provenance, and conventional Byzantine consensus each address a distinct portion of the trust gap presented by AI-generated code, but each conventionally operates as an isolated capability that admits AI-generated code into a downstream system without machine-checked, hardware-attributable, post-quantum-durable, and tamper-evident gating. The disclosed acceptance-control layer, depicted at a high level in FIG. 6, interposes a single, integrated decision boundary between AI generation and downstream consumption: candidate code is accepted only when (a) the machine-checkable proof has been successfully produced by the formal verification engine; (b) the attestation evidence has been produced by the quantum-resistant cryptographic module binding the candidate code, the AI agents, and the machine-checkable proof to the hardware-rooted measurement of the TEE using one or more post-quantum cryptographic algorithms; (c) a policy-defined consensus threshold has been satisfied by a plurality of validators whose eligibility is bound to the hardware-rooted measurement of the TEE; and (d) the candidate code, the machine-checkable proof, the attestation evidence, and the consensus decision have been recorded in a tamper-evident provenance ledger. The integration of all four conditions in a single architecture produces a new technical result that is not produced by any of the conditions in isolation and that is not produced by any conventional combination of those conditions: a single attested, post-quantum-durable, third-party-verifiable code artifact whose correctness properties have been machine-checked within a hardware-attested execution environment and whose acceptance can be independently confirmed by a third party without reliance on the operator. Each condition in isolation produces only a portion of this technical result; only the integrated architecture produces all four properties simultaneously and as a unified transferable artifact. The acceptance-control layer is the inventive concept of the present disclosure; the individual components are means by which the layer is realized.

### Prior-Art Categorical Comparison

The following table summarizes the categorical comparison set forth in paragraph across the principal capabilities provided by the disclosed acceptance-control layer. “Yes” denotes that an approach in the indicated category typically provides the indicated capability; “No” denotes that the capability is typically absent; “Partial” denotes that some instances within the category provide the capability in limited form. Categorical entries are descriptive only and do not constitute admissions of prior-art status of any specific reference.

| | | | Hardware- | | | |
|---|---|---|---|---|---|---|
| | | Formal | Rooted | Post- | Tamper- | Single |
| | AI Code | Verification | Validator | Quantum | Evident | Attested |
| Approach Category | Generation | In-Loop | Identity | Attestation | Provenance | Artifact |
| AI code assistants | Yes | No | No | No | No | No |
| and copilot interfaces | | | | | | |
| AI + formal-verification | Yes | Partial | No | No | No | No |
| pipelines(e.g., LLM with | | | | | | |
| Lean/Coq integration) | | | | | | |
| Standalone formal | No | No(offline) | No | No | No | No |
| verification tools | | | | | | |
| Confidential AI inference | Partial | No | Partial | No | No | No |
| in a single TEE | | | | | | |
| Blockchain-anchored | No | No | No | No | Yes | No |
| audit-log systems | | | | | | |
| Zero-knowledge proof | No | No | No | No | No | No |
| systems (general) | | | | | | |
| Byzantine fault-tolerant | No | No | Partial | No | Partial | No |
| consensus systems | | | | | | |
| Static analysis and | No | No(offline) | No | No | No | No |
| fuzz-testing pipelines | | | | | | |
| Federated learning over | No | No | Partial | No | No | No |
| TEEs | | | | | | |
| Present disclosure(integrated | Yes | Yes(real- | Yes | Yes | Yes | Yes |
| acceptance-control layer) | | time/ | | | | |
| | | bounded) | | | | |

No row in the foregoing table reflects the present disclosure other than the row designated “Present disclosure (integrated acceptance-control layer).” Reading down any single column establishes that no other categorical approach provides the corresponding capability with the integration described in the present disclosure; reading across the bottom row establishes that the present disclosure provides each capability simultaneously and in combined effect. The combinatorial integration is the inventive concept; preemption of any single capability in isolation is not asserted.

### FIG. 6—Consolidated Schematic of the Acceptance-Control Layer

FIG. 6 is a consolidated high-level schematic flow diagram of the acceptance-control layer disclosed herein, depicting in a single view the integration of components and operations otherwise distributed across FIG. 1 through FIG. 5. Whereas FIG. 1 through FIG. 5 detail individual components and operations of the acceptance-control layer (the trusted execution environment, the specialized AI agents, the formal verification engine, the cryptographic and consensus modules, and the provenance ledger), FIG. 6 depicts, at a single glance, the four gating conditions of paragraph and the structural relationship by which the disclosed acceptance-control layer prevents transmission of candidate code absent simultaneous satisfaction of those four conditions. FIG. 6 depicts, from input to output: (a) one or more inputs 202 entering the acceptance-control layer; (b) a candidate-code generation block representing the one or more specialized AI agents 210 executing within federated TEE network 220; (c) a formal-verification block representing formal verification engine 240 producing a machine-checkable proof of designated correctness properties; (d) an attestation block representing quantum-resistant cryptographic module 250 binding the candidate code, the specialized AI agents, and the proof to hardware-rooted measurement 222 using one or more post-quantum cryptographic algorithms; (e) a consensus-gating block representing hardware-rooted consensus engine 270, the consensus decision being conditioned upon the proof and upon satisfaction of consensus threshold 274 by a plurality of validators selected from the specialized AI agents, validator eligibility being bound to measurement 222; (f) a provenance-recording block representing tamper-evident provenance ledger 280, with Merkle root 286 anchored at one or more intervals to public-chain anchor 288; and (g) two outputs on the downstream side of the layer, comprising an accepted code artifact and a transferable proof-and-attestation package verifiable by an entity independent of an operator without reliance on the operator. The decision boundary depicted by FIG. 6 is the boundary at which candidate code transitions from AI-generated artifact to downstream-deployable artifact; no candidate code crosses the boundary absent satisfaction of the four gating conditions.

### Prediction-Market and Smart-Contract Embodiment

In a decentralized prediction-market or smart-contract embodiment, the disclosed acceptance-control layer generates and verifies smart-contract code intended for deployment to a public or permissioned blockchain. The candidate code may include conditional-token logic, oracle-resolution logic, escrow or settlement logic, governance logic, or any other on-chain executable. Regulatory compliance agent 210c applies machine-readable rulesets including, where applicable, securities-law compliance, anti-money-laundering provisions, and platform-specific market-integrity rules. Formal verification engine 240 discharges proof obligations including (a) absence of unauthorized fund transfers from designated escrow addresses, expressible as a blast-radius containment property under paragraph applied to on-chain value flow; (b) bounded-precision arithmetic to prevent overflow or precision-loss attacks; (c) deterministic resolution under specified oracle inputs; (d) absence of reentrancy and front-running vulnerabilities of designated classes; and (e) bounded gas or compute-unit consumption per execution path. Hardware-rooted consensus engine 270 may be configured to require at least two-thirds weighted approval, with deterministic rejection on any unauthorized value-flow finding by security analysis agent 210b. Provenance ledger 280 anchors per-deployment Merkle roots to the public blockchain on which the smart contract is to be deployed, producing a contract-deployment record that is publicly verifiable using the proof-of-inclusion protocol of paragraph [0081]. The transferable proof-and-attestation package of paragraph supports auditing of the deployed contract by regulators, exchange operators, oracles, and counterparties without disclosure of model internals.

### Preferred Mode of Carrying Out the Invention

At the time of filing, the inventor contemplates that a preferred mode of carrying out the disclosed acceptance-control layer comprises: a federated TEE network spanning AWS Nitro Enclaves 220f and Intel Trust Domain Extensions 220b connected by cross-trust-domain bridge 299 implementing remote attestation conformant with the IETF Remote Attestation Procedures (RATS) framework; orchestration layer 230 hosted within an AWS Nitro Enclave; formal verification engine 240 dispatching higher-order proof obligations to a theorem prover selected from Lean 4 or Coq and first-order obligations to an SMT solver selected from Z3 or CVC5; quantum-resistant cryptographic module 250 producing hybrid attestation signatures combining a classical signature algorithm with ML-DSA (Dilithium) and performing key establishment using ML-KEM (Kyber) in hybrid construction with a classical key-exchange algorithm; zero-knowledge proof module 260 producing intermediate proofs using a Groth16 or PLONK construction; provenance ledger 280 organized as a Merkle tree with roots anchored at a configurable interval to a public blockchain; and refinement loop controller 298 configured with a maximum iteration count appropriate to the regulated domain. The foregoing represents one preferred mode contemplated at filing; other modes disclosed herein and their equivalents are within the scope of the claims, and the inventor does not intend the disclosure of any preferred mode to limit claim scope.

### Supplemental Definitions

The following supplemental definitions are added in the present non-provisional application. Each defined term is used herein and in the appended claims with the meaning set forth below; in the event of any conflict between a definition in this section and the ordinary meaning to one of ordinary skill in the art, the definition in this section controls.

(a) “Acceptance-Control Layer” means an integrated computer architecture interposing a unified decision boundary between artificial-intelligence-generated candidate code and a downstream execution environment, the architecture comprising a hardware-enforced deployment gate structurally configured to prevent transmission of the candidate code across the decision boundary until simultaneous satisfaction of (i) production by a formal verification engine within a trusted execution environment of a machine-checkable proof of one or more designated correctness properties of the candidate code, (ii) production by a quantum-resistant cryptographic module of attestation evidence binding the candidate code, the producing AI agents, and the machine-checkable proof to a hardware-rooted measurement of the trusted execution environment using one or more post-quantum cryptographic algorithms, (iii) satisfaction of a policy-defined consensus threshold by a plurality of validators whose eligibility is bound to the hardware-rooted measurement, and (iv) recording of the foregoing in a tamper-evident provenance ledger. (b) “Hardware-Enforced Deployment Gate” (or “Deployment Gate”) means a control element of the acceptance-control layer, implemented in hardware-attested code executing within a trusted execution environment, that prevents transmission of candidate code to any execution environment outside the trusted execution environment until the conditions enumerated in subparagraph (a) are simultaneously satisfied. The hardware-enforced deployment gate is implemented by means of one or more of: a TEE-resident release controller controlling an attested output interface; a sealed release key bound to the hardware-rooted measurement of the TEE and invokable only upon simultaneous satisfaction of the conditions; a deployment-token generator producing release tokens only upon such simultaneous satisfaction; or a cryptographic signing key sealed within the TEE and producible only upon such simultaneous satisfaction. The deployment gate is structurally controlled by the hardware-rooted consensus engine and is not bypassable by software components executing outside the trusted execution environment. (c) “Machine-Checkable Proof” means a proof produced by a formal verification engine, the proof being expressible as a finite sequence of inference steps each verifiable by an automated proof checker, including without limitation a proof certificate produced by a satisfiability modulo theories (SMT) solver, a tactic-based proof produced by a theorem prover, a counter-example-free model produced by a model checker, or a Hoare-logic derivation; the validity of a machine-checkable proof is independently confirmable by re-execution of the proof checker against the proof certificate, without re-execution of the original generation procedure. (d) “Transferable Proof-and-Attestation Package” means a structured, machine-readable artifact comprising at minimum (i) one or more machine-checkable proof certificates, (ii) attestation evidence identifying the AI agents and the hardware-rooted measurement of the trusted execution environment, (iii) the consensus decision and validator identifiers, and (iv) a Merkle proof of inclusion of the foregoing to a publicly anchored root, the package being verifiable by an entity independent of an operator of the system without reliance on the operator and without re-execution of the original generation, verification, or consensus procedures.

### End-to-End Enablement Trace

An end-to-end illustrative trace of operation of the acceptance-control layer is set forth in the following paragraphs. The trace is exemplary and non-limiting; specific values, code fragments, algorithm selections, and quorum sizes are illustrative and not exhaustive of the embodiments within the scope of the claims. Step 1—Input. The acceptance-control layer receives an input specification at attested I/O channel 228. By way of non-limiting example, the input specification recites: “Implement a bounded-recursion JSON parser in Rust, with the pre-condition that the input string length does not exceed 65,536 bytes, and post-conditions that (P1) the parser terminates within 65,536 recursive calls for any input satisfying the pre-condition, (P2) the parser does not perform memory allocation outside a pre-supplied arena buffer, and (P3) the parser does not invoke any operation outside the set {input read, arena write, abstract-syntax-tree node construction}.”

Step 2—Generation. Code generation agent 210a, executing within trusted execution environment 220, generates a candidate Rust implementation of the JSON parser using its model parameters and the input specification. Step 3-Formal Verification. Formal verification engine 240, also executing within TEE 220, discharges three proof obligations corresponding to P1-P3. The recursion-depth bound P1 is verified by model checker 246 applied to the control-flow graph of the candidate code; the memory-containment property P2 and the capability-containment property P3 are discharged by SMT solver 242 over a model of the program effect set, implementing the blast-radius containment property of paragraph [0079]. The verification produces three proof certificates, one corresponding to each of P1, P2, and P3. Step 4-Attestation. Quantum-resistant cryptographic module 250 produces an attestation token comprising (i) the hardware-rooted measurement of TEE 220, (ii) a cryptographic hash of the candidate code, (iii) the three proof certificates, and (iv) the decentralized identifier of code generation agent 210a. The attestation token is signed using a hybrid signature combining a classical ECDSA over P-256 with ML-DSA (Dilithium) in accordance with the preferred mode of paragraph [0102].

Step 5—Consensus. Hardware-rooted consensus engine 270 collects votes from a quorum comprising code generation agent 210a, security analysis agent 210b, reproducibility agent 210f, and independent secondary cross-check agent 210g. Each validator verifies the attestation token and the three proof certificates and produces a post-quantum-signed vote. With three of four validators voting ACCEPT, the configured two-thirds consensus threshold is satisfied, and the deployment gate of claim 1 transitions from BLOCKED to OPEN. Step 6—Provenance. Provenance ledger 280 records the input specification, the candidate code, the three proof certificates, the attestation token, the four signed votes, and the consensus decision as a single ledger entry. The ledger entry is included in the current Merkle batch, and the resulting Merkle root is anchored to a public blockchain on the next anchoring tick. Step 7—Package and Output. The transferable proof-and-attestation package of claim 12 and claim 19 is generated, comprising the three proof certificates, the attestation token, the four validator vote signatures, the timestamp, and a Merkle proof of inclusion. The accepted candidate code transitions across the deployment gate to the downstream consumer, and the package is made available through third-party verifier interface 296. Any entity holding the package may, without reliance on the operator, reconstruct the full generation, verification, and consensus history from the ledger entry referenced by the package.

### Deployment Gate State Machine

The hardware-enforced deployment gate of claim 1, depicted in FIG. 6 as the gating block between candidate-code generation and downstream consumption, is implemented as a finite state machine executing in attested code within trusted execution environment 220. The state machine maintains four independent gating-condition flags, corresponding to conditions (a) through (d) of claim 1, namely (i) proof-produced, (ii) attestation-produced, (iii) consensus-threshold-met, and (iv) ledger-recorded. Each gating-condition flag occupies one of three values: PENDING (default initial value), SATISFIED (the corresponding condition has been verified within the TEE), or FAILED (the corresponding condition has been verified as not met or has exceeded a configurable timeout). The deployment gate itself maintains a top-level gate state in one of two values: BLOCKED (default initial value) or OPEN. The state machine transitions the gate state from BLOCKED to OPEN if and only if all four gating-condition flags are simultaneously in the SATISFIED state; the transition is atomic with respect to candidate-code transmission such that no candidate code crosses the gate in any state other than OPEN. The state machine returns the gate state from OPEN to BLOCKED, terminating any in-progress transmission, upon detection of one or more of: stale attestation evidence exceeding a configurable freshness bound, expiration of a per-deployment time-to-live, revocation of any validator identity whose vote contributed to the consensus decision, detection of an integrity violation of the provenance ledger, or receipt of a hard-gate rejection signal of the type described in claim 20. State transitions and their triggering conditions are recorded in provenance ledger 280 together with timestamps and identities of contributing agents and validators, enabling external reconstruction of the gate's behavior over the full lifetime of any candidate-code acceptance decision. Because the state machine and all four gating-condition checks execute within the TEE under attestation, the deploy-or-block mechanism is itself bound to the hardware-rooted measurement and cannot be bypassed by software components executing outside the TEE.

### FURTHER INDUSTRY APPLICATIONS

In addition to the healthcare embodiment of paragraph [0067], the defense and aerospace embodiment of paragraph [0068], and the prediction-market and smart-contract embodiment of paragraph [0101], the disclosed acceptance-control layer supports further industry applications including the following non-limiting examples. (a) Financial services. The acceptance-control layer is configured to generate and verify trading, settlement, market-making, or risk-management software, with proof obligations of formal verification engine 240 configured to include bounded slippage under specified market conditions, deterministic settlement under specified oracle inputs, conformance to capital-adequacy invariants, and absence of front-running, wash-trading, or reentrancy of designated classes. (b) Infrastructure-as-code and container deployment. The acceptance-control layer is configured to generate and verify declarative infrastructure code such as Kubernetes manifests, Terraform configurations, Helm charts, or container-orchestration manifests, with proof obligations configured to include resource-quota bounds, network-policy correctness, absence of privilege-escalation paths, and conformance to organizationally-defined least-privilege constraints. (c) Machine-learning model deployment. The acceptance-control layer is configured to generate and verify model weights, fine-tuning parameters, or fine-tuning configurations intended for deployment to a production inference environment, with proof obligations configured to include bounded model size, bounded inference-time compute, conformance to a designated alignment specification, and absence of designated unsafe-output classes under specified input conditions. In each industry application, the proof obligations discharged by formal verification engine 240 are configured per domain, the validator quorum of hardware-rooted consensus engine 270 is configured per applicable governance regime, and the resulting transferable proof-and-attestation package supports independent third-party audit by the regulator, exchange operator, certification authority, or counterparty appropriate to the domain.

Distinction from Conventional CI/CD and Deployment-Gate Pipelines

The disclosed acceptance-control layer differs in kind, and not merely in degree, from conventional continuous-integration and continuous-deployment (CI/CD) pipelines, conventional security-scanning gates, conventional code-review approval workflows, and conventional release-management systems. Conventional CI/CD pipelines apply test suites, static analysis tools, linting, and human or rule-based approval gates as a sequence of pre-deployment checks; however, conventional CI/CD pipelines: (i) rely on test execution or heuristic analysis rather than on machine-checkable formal proof of one or more correctness properties; (ii) do not execute their verification stages within a hardware-attested trusted execution environment producing a hardware-rooted measurement of the verification context; (iii) do not bind pipeline-step identity, tooling identity, or agent identity to such a hardware-rooted measurement; (iv) do not produce post-quantum cryptographic attestation of the verification process and its inputs; (v) do not enforce acceptance through hardware-rooted consensus among a plurality of validators whose eligibility is itself bound to hardware-rooted attestation; (vi) do not produce a single transferable proof-and-attestation package that is independently verifiable by a third party without reliance on the operator of the pipeline; and (vii) do not implement the acceptance decision through a hardware-enforced deployment gate of the type defined herein. The distinction is structural rather than merely additive: the disclosed acceptance-control layer is the integrated architecture. by which a single attested artifact bearing the four gating conditions of paragraph is produced; a conventional CI/CD pipeline does not conventionally produce such an artifact and, even when augmented with formal-verification tooling, security-scanning tooling, or signed release artifacts, does not conventionally produce the integrated four-condition gating disclosed herein.

What is claimed is:

1. A system for controlling acceptance of artificial-intelligence-generated software code, the system comprising:
a trusted execution environment (TEE) configured to produce a hardware-rooted measurement of its software state;
one or more specialized artificial intelligence (AI) agents executing within the TEE and configured to generate candidate code from one or more inputs;
a formal verification engine executing within the TEE and configured to produce a machine-checkable proof of one or more correctness properties of the candidate code;
a quantum-resistant cryptographic module configured to produce attestation evidence binding the candidate code, the one or more specialized AI agents, and the machine-checkable proof to the hardware-rooted measurement using one or more post-quantum cryptographic algorithms;
a hardware-rooted consensus engine; and
a hardware-enforced deployment gate controlled by the hardware-rooted consensus engine, the hardware-enforced deployment gate being implemented by one or more of: a TEE-resident release controller controlling an attested output interface; a sealed release key bound to the hardware-rooted measurement of the TEE and invokable only upon simultaneous satisfaction of the conditions enumerated below; a deployment-token generator producing release tokens only upon such simultaneous satisfaction; or a cryptographic signing key sealed within the TEE and producible only upon such simultaneous satisfaction; the hardware-enforced deployment gate being configured to prevent transmission of the candidate code to any execution environment outside the TEE until all of the following conditions are simultaneously satisfied: (a) the machine-checkable proof has been successfully produced by the formal verification engine; (b) the attestation evidence has been produced by the quantum-resistant cryptographic module; (c) a policy-defined consensus threshold has been satisfied by a plurality of validators selected from the one or more specialized AI agents, the eligibility of each validator being bound to the hardware-rooted measurement of the TEE in which the validator executes; and (d) the candidate code, the machine-checkable proof, the attestation evidence, and the consensus decision have been recorded in a tamper-evident provenance ledger;
the system thereby improving the functioning of the computer system itself by (i) structurally preventing transmission of code lacking machine-checked correctness properties to any execution environment outside the TEE, (ii) binding eligibility of each consensus validator to the hardware-rooted measurement of the TEE in which the validator executes, and (iii) producing a tamper-evident record durable against future cryptanalytic attack by quantum computers.

2. A computer-implemented method for controlling acceptance of artificial-intelligence-generated software code, the method comprising:
generating candidate code by one or more specialized artificial intelligence (AI) agents executing within a trusted execution environment (TEE) configured to produce a hardware-rooted measurement of its software state;
producing, within the TEE, a machine-checkable mathematical proof of one or more correctness properties of the candidate code by a formal verification engine;
producing, by a quantum-resistant cryptographic module, attestation evidence binding the candidate code, the one or more specialized AI agents, and the machine-checkable mathematical proof to the hardware-rooted measurement using one or more post-quantum cryptographic algorithms;
performing hardware-rooted consensus among a plurality of validators selected from the one or more specialized AI agents, the eligibility of each validator being bound to the hardware-rooted measurement, the consensus producing a consensus decision;
recording the candidate code, the machine-checkable mathematical proof, the attestation evidence, and the consensus decision in a tamper-evident provenance ledger; and
transmitting the candidate code to an execution environment outside the TEE, via a hardware-enforced deployment gate implemented by one or more of a TEE-resident release controller, a sealed release key, a deployment-token generator, or a cryptographic signing key sealed within the TEE, only upon simultaneous satisfaction of (a) successful production of the machine-checkable mathematical proof, (b) production of the attestation evidence, (c) satisfaction of a policy-defined consensus threshold by the plurality of validators, and (d) recording of the foregoing in the tamper-evident provenance ledger;
the method thereby improving the functioning of the computer system itself by (i) structurally preventing transmission of the candidate code absent machine-checked proof produced contemporaneously with generation, (ii) cryptographically binding consensus eligibility to the hardware-rooted measurement of the TEE, and (iii) producing a tamper-evident record durable against future cryptanalytic attack by quantum computers.

3. A non-transitory computer-readable medium storing instructions that, when executed by one or more processors, cause the one or more processors to perform operations comprising:
instantiating a trusted execution environment (TEE) configured to produce a hardware-rooted measurement of its software state;
generating candidate code by one or more specialized artificial intelligence (AI) agents within the TEE;
producing, within the TEE, a machine-checkable proof of one or more correctness properties of the candidate code by a formal verification engine;
producing attestation evidence binding the candidate code, the one or more specialized AI agents, and the machine-checkable proof to the hardware-rooted measurement using one or more post-quantum cryptographic algorithms;
executing hardware-rooted consensus among a plurality of validators selected from the one or more specialized AI agents, the eligibility of each validator being bound to the hardware-rooted measurement, the consensus producing a consensus decision;
recording the candidate code, the machine-checkable proof, the attestation evidence, and the consensus decision in a tamper-evident provenance ledger; and
controlling a hardware-enforced deployment gate, the hardware-enforced deployment gate being implemented by one or more of a TEE-resident release controller, a sealed release key bound to the hardware-rooted measurement, a deployment-token generator, or a cryptographic signing key sealed within the TEE, to transmit the candidate code to an execution environment outside the TEE only upon simultaneous satisfaction of (a) successful production of the machine-checkable proof, (b) production of the attestation evidence, (c) satisfaction of a policy-defined consensus threshold by the plurality of validators, and (d) recording of the foregoing in the tamper-evident provenance ledger;
the operations thereby improving the functioning of the computer system itself by (i) structurally preventing transmission of the candidate code absent a machine-checkable proof of designated correctness properties, (ii) binding consensus eligibility to the hardware-rooted measurement of the TEE, and (iii) producing a tamper-evident record durable against future cryptanalytic attack by quantum computers.

4. The system of claim 1, wherein the one or more specialized AI agents comprise a plurality of specialized AI agents including at least: a code generation agent, a security analysis agent applying signatures from the Common Weakness Enumeration (CWE) and Common Vulnerabilities and Exposures (CVE) registries, a regulatory compliance agent, a refinement agent, an alignment scoring agent, a reproducibility agent, and an independent cross-validation agent comprising a second AI model independent of the code generation agent.

5. The system of claim 1, further comprising an orchestration layer executing within the TEE and configured to spawn the one or more specialized AI agents, the orchestration layer including dynamic spawning logic configured to instantiate one or more additional specialized AI agents in response to at least one of: an input complexity exceeding a threshold, a formal verification failure rate exceeding a threshold, an alignment score below a threshold, or a failure of the consensus engine to satisfy the consensus threshold.

6. The system of claim 1, further comprising one or more additional trusted execution environments instantiated on heterogeneous hardware platforms, the trusted execution environment of claim 1 and the one or more additional trusted execution environments forming a federated TEE network spanning at least two of: Intel Software Guard Extensions (SGX), Intel Trust Domain Extensions (TDX), AMD Secure Encrypted Virtualization with Secure Nested Paging (SEV-SNP), ARM TrustZone, ARM Confidential Compute Architecture (CCA), AWS Nitro Enclaves, Azure Confidential Virtual Machines, Google Cloud Confidential Virtual Machines, or a graphics processing unit configured in a confidential computing mode; the system further comprising a cross-trust-domain bridge configured to provide mutually attested, post-quantum-secured communication between trusted execution environments of the federated TEE network; and wherein the cross-trust-domain bridge implements a remote attestation handshake conformant with the IETF Remote Attestation Procedures (RATS) framework, comprising an exchange of attestation evidence in an Entity Attestation Token (EAT) format between the trusted execution environment of claim 1 and each of the one or more additional trusted execution environments, the handshake establishing mutually verified post-quantum-secured channels between trust domains of heterogeneous hardware vendors prior to any cross-trust-domain communication.

7. The system of claim 1, wherein each of the one or more specialized AI agents is provisioned with a self-sovereign agent identity comprising a decentralized identifier (DID) the control of which is bound by cryptographic linkage to the hardware-rooted measurement of the TEE in which the specialized AI agent executes, wherein a private key associated with the DID is sealed to the hardware-rooted measurement such that signatures are producible only while the TEE is in an authorized state matching the sealed measurement, and wherein at least one cryptographic key used by the quantum-resistant cryptographic module to produce the attestation evidence is derived, by a key derivation function (KDF), from one or more values comprising the hardware-rooted measurement of the TEE, such that a change in the hardware-rooted measurement results in a derived key incapable of producing valid attestation evidence.

8. The system of claim 1, further comprising a zero-knowledge proof module configured to produce zero-knowledge intermediate proofs by which one specialized AI agent demonstrates to another specialized AI agent or to the consensus engine the correctness of a computation, the possession of a property, or the satisfaction of a constraint without revealing underlying inputs, intermediate states, or model internals, wherein the zero-knowledge intermediate proofs are recorded in the provenance ledger; and wherein the zero-knowledge proof module implements a proving system selected from at least one of Groth16, PLONK, Marlin, a zk-STARK construction, or Bulletproofs, the proving system operating over a constraint system in which the witness comprises one or more of the candidate code, model parameters, sampling parameters, or intermediate activations of the specialized AI agent producing the proof, and the statement comprises the property to be demonstrated to the verifying agent or the consensus engine.

9. The system of claim 1, wherein the one or more post-quantum cryptographic algorithms comprise at least one of: ML-KEM (CRYSTALS-Kyber, standardized as NIST FIPS 203), ML-DSA (CRYSTALS-Dilithium, standardized as NIST FIPS 204), SLH-DSA (SPHINCS+, standardized as NIST FIPS 205), FN-DSA (Falcon, selected by NIST for post-quantum signature standardization), or any successor or equivalent post-quantum cryptographic algorithm published by the National Institute of Standards and Technology or other recognized standards body; and wherein the hardware-rooted consensus engine is configured to apply weighted Byzantine fault-tolerant voting with weights derived from agent role, attestation freshness, and agent performance history.

10. The system of claim 1, wherein the formal verification engine is configured to prove at least one property selected from: functional correctness against a precondition and a postcondition, type-safety, memory-safety, race-freedom, termination or bounded termination, absence of one or more specified vulnerability classes, conformance to a temporal-logic safety or liveness specification, and a blast-radius containment property bounding state, memory regions, network destinations, file paths, or capabilities affected by execution of the code.

11. The system of claim 1, wherein the formal verification engine comprises at least one of a satisfiability modulo theories (SMT) solver, a theorem prover, a model checker, or a Hoare-logic assertion module, each executing within the TEE such that the machine-checkable proof and the proof-checking environment are bound by attestation evidence to the hardware-rooted measurement of the TEE.

12. The system of claim 1, further comprising a transferable proof-and-attestation package generator configured to produce a package comprising (i) a machine-checkable proof certificate identifying the candidate code, the one or more correctness properties proven, and the proof-system parameters under which the proof was checked; (ii) attestation evidence identifying each specialized AI agent that contributed to the candidate code and the hardware-rooted measurement of the TEE in which the specialized AI agent executed; (iii) the consensus decision and identifiers of the validators whose votes formed the consensus; and (iv) a timestamp and a proof of inclusion of the package to a Merkle root anchored, at one or more intervals, to a public blockchain; wherein the package is serialized in a structured, machine-readable format comprising a header section containing at least the timestamp, the validator identifiers, and a cryptographic hash of the candidate code, a body section containing at least the proof certificate and the attestation evidence, and a trailer section containing at least the Merkle path and a public-blockchain transaction reference; the package being verifiable by an entity independent of an operator of the system without reliance on the operator.

13. The system of claim 1, further comprising a neuromorphic scheduler configured to allocate workloads of the formal verification engine to one or more hardware accelerators selected from a tensor-streaming accelerator, a field-programmable gate array, a neuromorphic processor, a spiking-neural-network accelerator, or a graphics processing unit operating in a confidential computing mode, the neuromorphic scheduler being configured to reduce wall-clock execution time of the formal verification engine while preserving attestation of the proof-checking environment to the hardware-rooted measurement of the TEE.

14. The method of claim 2, further comprising executing a refinement loop in which at least one specialized AI agent iteratively modifies the candidate code in response to feedback from the formal verification engine, the refinement loop being characterized by (a) a configurable maximum iteration count, (b) a per-iteration solver-timeout limit beyond which an iteration is recorded as inconclusive, (c) declaration of an acceptance state upon successful proof of all designated correctness properties, (d) declaration of a deterministic rejection state upon expiration of the maximum iteration count or upon recurrent inconclusive results for designated properties, and (e) recording of each iteration, including its candidate code, formal verification result, and termination state, in the provenance ledger; wherein upon a failed iteration the formal verification engine produces a counterexample comprising one or more specific input values violating one or more of the designated correctness properties, and a refinement agent of the specialized AI agents modifies the candidate code in a subsequent iteration in response to the counterexample, the modification being conditioned on the one or more specific input values returned by the counterexample; and further comprising collecting runtime telemetry from the candidate code following transmission outside the TEE, recording the runtime telemetry in the provenance ledger, and providing the runtime telemetry as additional feedback to the refinement agent for use in subsequent refinement iterations.

15. The method of claim 2, further comprising computing an alignment score for the candidate code based on one or more machine-measurable criteria comprising at least one of: maximum resource consumption bounds, bounded cyclomatic complexity, machine-readable policy-rule evaluation outcomes, and presence-or-absence of designated vulnerability-class signatures; deterministically rejecting the candidate code if the alignment score is below an alignment threshold; and recording the alignment score and any rejection in the provenance ledger.

16. The method of claim 2, wherein the tamper-evident provenance ledger comprises a Merkle tree of ledger entries the root of which is anchored, at one or more configurable intervals, to a public blockchain; the method further comprising supplying, in response to a request from an entity independent of an operator of the method, a proof of inclusion of a specified ledger entry, the proof of inclusion comprising a leaf hash, a sibling-path hash sequence, and a public-blockchain transaction reference.

17. The method of claim 2, wherein the candidate code comprises at least one of: (a) medical-device software conformant to IEC 62304 or to FDA 21 C.F.R. Part 11; (b) flight-control, mission-system, or avionics software conformant to DO-178C Level A or Level B; (c) financial-services trading, settlement, market-making, or risk-management software; (d) blockchain smart-contract code intended for deployment to a public or permissioned blockchain; (e) infrastructure-as-code, container-manifest, or declarative-deployment code; or (f) machine-learning model weights, fine-tuning parameters, or fine-tuning configurations intended for deployment to a production inference environment; and wherein proof obligations discharged by the formal verification engine are configured to the technical requirements of the selected candidate code type.

18. The method of claim 2, wherein the TEE forms part of a federated TEE network spanning trusted execution environments of at least two heterogeneous hardware vendors, and wherein communication among specialized AI agents across the federated TEE network occurs over mutually attested, post-quantum-secured channels established by a cross-trust-domain bridge implementing remote attestation conformant with the IETF Remote Attestation Procedures (RATS) framework.

19. The non-transitory computer-readable medium of claim 3, the operations further comprising producing a transferable proof-and-attestation package comprising (i) a machine-checkable proof certificate identifying the candidate code, the one or more correctness properties proven, and the proof-system parameters under which the proof was checked; (ii) attestation evidence identifying each specialized AI agent that contributed to the candidate code and the hardware-rooted measurement of the TEE; (iii) the consensus decision and identifiers of the validators whose votes contributed to the decision; and (iv) a timestamp and a proof of inclusion of the package to a Merkle root anchored, at one or more intervals, to a public blockchain; and exposing an application programming interface configured to deliver the package, over a post-quantum-secured channel, to one or more of an external policy enforcement engine, a runtime attestation system, an insurance underwriting system, a capital-reserve calculation system, an enterprise risk management system, or a regulatory reporting system; the package being verifiable by an entity independent of an operator without reliance on the operator.

20. The non-transitory computer-readable medium of claim 3, the operations further comprising deterministically rejecting the candidate code, regardless of weighted vote totals of the hardware-rooted consensus engine, in response to at least one of: a critical Common Weakness Enumeration (CWE) finding by a security analysis agent of the specialized AI agents, a formal-verification timeout or inconclusive result for a designated correctness property, a hard-gate failure on a designated alignment dimension, or a stale or invalid attestation evidence from any specialized AI agent participating in the consensus decision; and recording the rejection and its triggering condition in the provenance ledger.
